(19) United States
(12) Patent Application Publication
(10) Pub. No.: US 2009/0286902 A1
(43) Pub. Date: Nov. 19, 2009

(54) Cast Solid Surface Materials Manufactured From Polymers and Post-Consumer Waste Glass

(76) Inventor: Louis P. Grasso, JR., New Rochelle, NY (US)

Correspondence Address: GORDON & JACOBSON, P.C., 60 LONG RIDGE ROAD, SUITE 407, STAMFORD, CT, 06902, US

(21) Appl. No.: 12/512,131

(22) Filed: Jul. 30, 2009

Related U.S. Application Data
(63) Continuation-in-part of application No. 12/120,743, filed on May 15, 2008.
Application No. 12/120,743 is a continuation-in-part of application No. 11/012,726, filed on Dec. 16, 2004, now Pat. No. 7,413,602.
(60) Provisional application No. 61/084,802, filed on Jul. 30, 2008.

(51) Int. Cl. C08K 3/40; C08K 3/34; C08K 3/26; C08L 63/00

(52) U.S. Cl. 523/458; 524/494; 524/442; 524/425; 523/466

(57) ABSTRACT

A solid surface material suitable for use as a countertop contains a resin and a filler which includes clean dry glass powder produced from unsorted post-consumer waste glass, including a substantial fraction of non-glass items. The powdered glass is used as at least a portion of the filler and/or gelling agent in lieu of or in addition to other fillers and gelling agents known in the art.

### CROSS-REFERENCE TO RELATED APPLICATIONS

This application is a continuation-in-part of U.S. Ser. No. 12/120,743, filed May 15, 2008, which is a continuation of U.S. Ser. No. 11/012,726, filed Dec. 16, 2004, now issued as U.S. Pat. No. 7,413,602, which are hereby incorporated by reference herein in their entireties. This application also claims the benefit of U.S. provisional Ser. No. 61/084,802, filed Jul. 30, 2008, which is hereby incorporated by reference herein in its entirety.

### BACKGROUND OF THE INVENTION

1. Field of the Invention

This invention relates to cast solid surface materials incorporating polymerizable compositions. Specifically, the invention relates to polymerizable compositions that contain clean and dry glass powder produced from un-sorted, post-consumer waste glass, and the uses of such compositions, including, but not limited to, countertop surface applications.

2. State of the Art

Stone formations such as granite and marble have a natural beauty that, over the years, has inspired the commercial production of various man-made synthetic-filled polymeric compositions that are useful for countertops and floors while providing an aesthetic appearance that resembles granite, marble, or other types of stone. These synthetic materials typically incorporate resin and inorganic fillers, and are cured using curing systems that are actuated at room temperature or under similar ambient conditions. Some of these products consist of polymeric resin highly filled with inorganic particles and pigments, and generally require gel coats to reduce or eliminate the susceptibility of the products to stress cracking and/or staining. The resins were historically produced by mixing a filler such as calcium carbonate with an epoxy or polyester type resin, and thereafter adding and manually swirling these materials in a pigment before gelation or curing. Such manual processes did not produce reproducible patterns generally uniform in appearance with respect to dimension, shape, direction, depth, and other characteristics. U.S. Pat. No. 3,488,246 teaches a process for providing such uniformity and reproducibility to the commercial production of polymeric compositions that simulate natural stone such as marble. The process generally involves bringing together, under controlled temperature, pressure, and flow rate conditions, monomer and polymer sirups, fillers, base-colored pigments, catalysts, promoters, and modifiers in a reaction zone, subjecting the materials to a high intensity mixing action, adding separate streams of pigments in a second zone at controlled rates to form vein patterns differing from the base color of the materials, and extruding the mixed materials through an orifice to a mold assembly for complete polymerization and/or cure.

The polymerizing media into which the pigments are added and mixed need to be cured within a specific time period so that gelation is substantially complete before the pigments and fillers settle out and destroy the pattern, but not before the casting or molding operation is complete. Such requirements give rise to viscosity considerations, which are satisfied through the use of inert fillers held together with a translucent polymer. Materials generally used as fillers are titanium dioxides, titanates, barium sulfates, calcium carbonate, white leads, lithopone, china clays, magnesite, mica, iron oxides, Spanish, Persian, and American siennas, etc. For special effects, it is known in the art to use fillers that comprise glass frits, beads, powders, fibers and/or metallic, organic, or inorganic fibers of varying size, shape or color and combinations of these items. The color imparted by the filler is referred to as the base color.

U.S. Pat. No. Re. 27,093 discloses that by using at least 40% of a filler, relatively thick (¼″ to 2″) articles can be produced in a commercially acceptable fashion in terms of the efficiency of the process and the appearance of the final product. The fillers recommended are those which do not interfere with the polymerization of an acrylic resin, such as calcium carbonate, calcium sulfate, clay, silica, glass, calcium silicate, alumina, carbon black, titania, powdered metals, etc.

U.S. Pat. No. 3,847,865 discloses the use of alumina trihydrate as a filler in acrylic polymers to produce a structure particularly useful as a kitchen or bathroom countertop by virtue of its resistance to stress cracking and staining by common household materials, as well as its appearance and safety characteristics such as increased translucency and flame resistance. U.S. Pat. Nos. 3,488,246; Re 27,093; and 3,847,865 are believed to correspond to DuPont's product sold under the brand name CORIAN.

U.S. Pat. No. 6,387,985 discloses a composition for a surfacing material comprising an acrylic resin matrix, a tri-functional acrylic monomer, and a filler comprised of crushed natural stone. The degree of cross-linking (bonding or linking of the polymer chains) in the acrylic resin matrix is controlled by the concentration of the tri-functional monomer, which in turn effects the stiffness and other mechanical characteristics of the resulting part, including its ability to absorb stresses before cracking. These stresses are in part caused by mismatches in the thermal expansion coefficients between the polymer and the stone filler employed in the invention. The initiators used are free radicals well known in the art such as peroxides (peroxydicarbonates, peroxyesters, and dialkyl peroxides) and Azo type initiators (Vazo® 52, Vazo® 64, and Vazo® 67, which are registered trademarks of E.I. DuPont de Nemours & Co.). The coupling agent used is a small molecule that aids in the dispersion of a solid particulate material into a liquid medium, such as silanes, titanates, and zirconates. The crushed natural stone filler is disclosed as being any fragment of rock or mineral matter found in nature.

U.S. Pub. No. 2006/0293449 discloses a polymerizable composition containing a monoethylenically unsaturated resin polymerizable by a free radical initiator, a phosphoric acid ester, an epoxy, a free radical initiator, and a solid filler comprising at least 10% (and preferably at least 50%) by weight of the composition, and a method for preparing the polymerized composition. The composition and method helps to produce more uniformity between parts and to prevent the stone fillers from settling out of the castable resins while maintaining a low enough viscosity to enable a reasonable flow of the composition and proper deaeration of entrained air during mixing. Various fillers are disclosed, including pigments and dyes, reflective flakes, micas, metal particles, rocks, colored glass, colored sand of various sizes, sea shells, wood products such as fibers pellets and powders, and others. A preferred silica-based material for engineered stone-type products includes materials such as quartz, sand, and glass. Sag control agents known as gelling agents may be used, such as bis urea crystals, cellulose acetate butyrates (CAB), metal organic gellants such as aluminates, titanates, and zirconates, high aspect fibers, polymer powders, filler bridging agents, and fumed silica.

While numerous mixtures and methods are thus known in the art for producing various polymerizable compositions, industry demands have gave given rise to the need for producing cheaper, safer, and more environmentally friendly products that offer the same or improved functional benefits and aesthetic qualities.

### SUMMARY OF THE INVENTION

The invention is directed to cast solid surface materials suitable for use as a countertop that preferably simulate natural stone and utilize as a gelling agent and/or filler in various polymerizable compositions dry glass powder produced from un-sorted, post-consumer waste glass. The glass powder, when used as a gelling agent and/or filler as disclosed herein, provides at least partial replacement of various gelling agents and/or fillers known in the art. The glass powder is produced from a continuous process that 1) employs glass pulverizing equipment to reduce un-sorted post consumer waste glass to small fragments, allowing removal of trash therefrom, 2) employs a multistep washing process to clean the glass fragments (and in the preferred embodiment utilizes aggregate cleaning equipment), 3) dries the fragments, preferably using fluidized bed techniques, and 4) grinds the glass to a desired particle size, preferably using a ball mill, in conjunction with an air classification step, to produce a glass powder of generally uniform particle size. This process produces very small glass powder particles having high aspect, angular surfaces, tegular in form, which cause the particles to align in the various polymerizable compositions and increase the tensile strength thereof. The alignment of the particles in the compositions also allows for a large packing ratio (concentration) of the glass powder per unit volume, which facilitates its use as a sag control agent or gelling agent to control a composition's viscosity as its components are mixed.

The glass powder produced by the process disclosed herein also has minimal surface tension with ambient air, which results in less air being trapped in the various compositions as their as their components are mixed. In addition, the glass powder provides increased fire retardation and heat stabilization, is cheaper and more environmentally friendly than other gelling agents and fillers known in the art, reduces the cost of producing cast solid surface materials, allows for a more “green” manufacturing process, and accords manufacturers who use it a greater NSF rating.

Preferably, the glass powder is mixed with a polymeric resin, as well as with various fillers, catalysts, promoters, and/or modifiers known in the art. In the various embodiments described herein, the glass powder at least partially replaces typical sag agents such as aluminates, titanates, and zirconates. In other embodiments, the glass powder at least partially replaces inert fillers of the polymerized compositions.

### BRIEF DESCRIPTION OF THE DRAWINGS

FIG. 1 is a schematic depiction of the process of the invention for producing glass powder from post-consumer waste glass.

FIG. 2 shows an elevational view of the equipment employed to perform a first step in the process of FIG. 1.

FIG. 3 shows a perspective, partly cut away view of a ball mill.

FIG. 4 shows a cross-sectional view through a classifier.

FIG. 5 is an electron micrograph of the particles of the glass powder produced by the process of FIG. 1.

### DESCRIPTION OF THE PREFERRED EMBODIMENTS

Reference will now be made in detail to the embodiments of the invention, examples of which are illustrated in the accompanying drawings. While the invention will be described in conjunction with the embodiments, it will be understood that the description is not intended to limit the invention to those embodiments. On the contrary, the invention is intended to cover alternatives, modifications, and equivalents, which may be included within the sprit and scope of the invention as defined by the appended claims.

As noted above, the present invention relates to cast solid surface materials suitable for use in countertop applications that preferably simulate natural stone and utilize as a gelling agent and/or filler in various polymerizable compositions dry glass powder produced from un-sorted, post-consumer waste glass. The invention allows a portion of the least recyclable waste glass stream, that of mixed-color broken post-consumer waste glass, now being disposed of primarily in landfills, to be used in a manufactured countertop.

More specifically, a typical stream of post-consumer waste glass, as ordinarily available from a municipal recycling facility, contains up to 30% by weight of various trash, including metal items, paper, and plastic, as well as various organics, such as foodstuffs and residues, as well as a certain amount of dirt picked up in handling the waste stream. According to the invention, the glass is separated from such streams and processed to a clean, dry, uniform glass powder suitable for a variety of applications, and specifically used as a substitute for a gelling agent and/or a filler in various polymerizable compositions created for countertop surface applications.

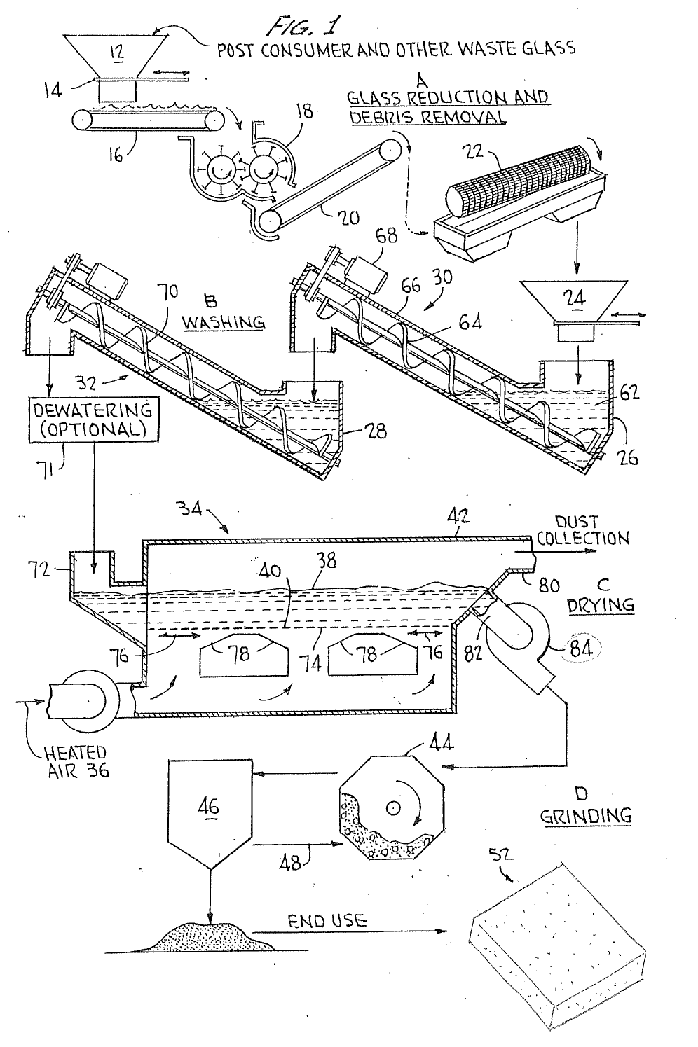

FIG. 1 shows the principal steps A-D in the process of the invention, and depicts equipment for the practice of each step schematically. The additional drawings which follow illustrate some of the equipment components in more detail, to fully enable the practice of the invention.

The process begins with a first step A, termed Glass Reduction and Debris Removal. A stream 10 of post-consumer waste glass, including a substantial fraction of non-glass trash as described above, as well as glass from other sources if available, is provided to a surge hopper 12. As is well known in the art, a surge hopper is essentially a bin, typically funnel-shaped, fitted with a metering device 14, such as a reciprocating plate feeder, gate valve, or vibratory feeder, for controllably dispensing a solid material by gravity. In this case the surge hopper is used to meter out the stream of waste glass, mixed to greater or lesser degree (typically up to 30% by weight, as mentioned) with various undesired items of metal, plastic, paper, ceramics, foodstuffs, and the like, onto a conveyor belt 16. Belt 16 feeds the stream into a pulverizer 18, which may be essentially as shown in U.S. Pat. No. 5,944,268 to James Andela.

The glass in the waste stream is selectively reduced by the pulverizer into small fragments, typically ⅜″ or less maximum dimension, so that these glass fragments can effectively be removed from larger items of non-frangible materials, such as steel, aluminum, paper, and plastic, by simple size-based separation. Paper, e.g., bottle labels, is usually removed from the glass fragments in the pulverizer as well. The small amount of ceramic material found in the typical stream of post-consumer waste glass can be processed together with the glass without detriment.

The pulverized glass is then delivered by a further conveyor belt 20 to a trommel 22, for further separation of the glass fragments by size, and further removal of larger particles of unwanted material. For example, glass “sand” of ⅛″ or less is preferred for downstream processing, so glass fragments of larger size can be separated out and returned to the pulverizer for further reduction, or can be set aside for use in different markets, e.g. as a constituent in asphalt for road-building. Trommel 22 may be as disclosed in U.S. Pat. No. 5,620,101 to Andela et al. Thus, in the first step A of the method, a stream of contaminate-free glass “sand” on the order of ⅛″ is produced using a pulverizing and separation system comprising a surge hopper, pulverizer, and trommel. This process removes the larger fragments of extraneous material such as metals and plastics that are included in the collected glass, and pulverizes the glass into granules of substantially uniform size.

Step B of the process involves washing the glass sand, as noted. After pulverizing, the glass granules are fed via a conveyor to a washing system that consists of an infeed hopper 24, two or more basins 26 and 28 filled with water that is recirculated (that is, periodically withdrawn, filtered and returned), and a like number of helical conveyors 30 and 32 encased in metal tubes. Thus, the glass granules fall through the infeed hopper 24 into the first basin 26 where water washes the glass. In the basin, any paper and plastic that may remain tend to float to the surface, and can be removed, while sugars and other organic materials adhering to the glass particles are dissolved in the water, while the glass particles sink. An auger screw 64 then picks up the glass granules on the bottom of the basin and conveys them through a metal encased screen tube; at its end, the glass granules drop into a second basin 28 and are washed again. A second encased auger screw 70 then conveys the glass out of the system. The particles are dewatered to an extent as they are lifted by the screw conveyor; a further dewatering step 71 can be incorporated before the subsequent drying step if desired. It will be appreciated that other forms of washing equipment, e.g., known wet screening or spray tumbling equipment, might instead be used.

Step C, as indicated, is that of drying the washed glass particles. In the preferred embodiment, this is accomplished by employment of a fluidized bed drying system 34; however, it will be appreciated that other forms of drying equipment, e.g., known tumbler drying equipment, or a rotary kiln, might instead be used. The design of suitable fluidized bed equipment is discussed in detail by Adham, Classify Particles Using Fluidized Beds, CEP Magazine, 54-57 (2001). The fluidized bed apparatus 34 uses a furnace to dry the glass granules by forcing a stream of hot, pressurized air through the glass granules 38, shown resting on or suspended in the air stream just above a vibrating or oscillating perforated plate or screen 40. The process causes some light weight materials such as glass fines to become airborne. To capture these fines and to trap the hot air for recirculation, the bed has a dust collector 42 over its top. The vibrating screen 40 then transports the glass granules to the exit 84 of the fluidized bed equipment 34 from which they are transported to step D.

Step D involves grinding the glass particles, as noted above typically of ⅛″ or less, to a fine powder of approximately 250 mesh minus, and more preferably 325 mesh minus. The preferred equipment for this step is a ball mill 44. Ball milling is a well-known process capable of rapidly grinding the glass particles to colloidal fineness. Briefly, ball milling is accomplished by admitting a quantity of the glass sand to a rotating steel drum, together with grinding media, such as high mass balls. The balls may be, e.g., steel balls. However, where metal is used for the drum inner surface and grinding media, there is the potential for metal microparticulates to discolor the powder and result in the powder acquiring a grayish tint. If the desired end result is a bright white glass powder, then the milling processing is modified to increase the brightness of the powder. More specifically, the drum of the ball mill 44 is lined with a non-metal, such as stone, and preferably jasper quartz. The jasper quartz is preferably five to six inches thick and adhered to the inner surface of the drum by way of rapid-set high-strength cement. In addition, the grinding media has a non-metallic surface. The grinding media is preferably ceramic cylinders that are preferably 1 to 1¼ inches in diameter and preferably 1 to 2 inches in length. Ceramic media of other shapes and sizes, including spherical and conical can also be used. All such shapes of ceramic grinding media are considered ceramic ball media for the grinding mill process. The ceramic media and glass are preferably provided in the drum in a volumetric ratio of 3:7 to 7:3. The ceramic ball media is advantageous to the process; when the ball media grinds down from use over time, new ball media is added without disrupting the process. As a less desirable alternative, ceramic-coated or other non-metallic coated grinding media can be used. However, as the coating is worn away from the grinding media during the grinding process, the grinding process may need to be temporarily halted to replace some or all of the grinding media.

It will be appreciated that other forms of fine grinding equipment, e.g., vibratory rod mills or jet mills, might be used instead.

The glass powder produced by the mill is then conveyed via a pneumatic conveyor to a classification system 46 which captures the 250 mesh or smaller powder by using vacuums to pull this material away from any heavier material. The heavier material is then sent back to the ball mill as indicated at 48 for further grinding, or can be collected for other uses if desired. Having thus been reduced to a 250 mesh or smaller size, the glass is ready for use in various applications, e.g., as indicated at 52, as an at least partial replacement for gelling agents and/or fillers used in polymerizable compositions created for countertop applications.

As mentioned above, FIG. 2 shows an elevational view of the equipment employed to perform the first step A in the process of the invention, that is, reduction of irregularly-sized glass objects and fragments, as typically found in post-consumer waste streams, to substantially uniformly sized glass particles, while removing trash therefrom, including paper, metal, and plastic. As described above, a typical stream of post-consumer waste glass, as obtained from the typical municipal waste facility, may in fact contain up to 30% by weight of non-glass trash of various sorts, which must be removed from the glass in the stream.

The stream of post-consumer glass and admixed undesirable material 10 is admitted to the surge hopper 12. A suitable surge hopper 12 is available from Andela Products, Ltd. of Richfield Springs, N.Y. under model number AMSH-86F. A reciprocating plate feeder 14 controls flow of the stream onto a first conveyor 16, which transports it to pulverizer 18. A magnetic separator is preferably mounted above conveyor 16, to remove ferrous material from the process stream. A suitable pulverizer is available from Andela Products, Ltd. of Richfield Springs, N.Y. under model number GP-2. As noted, pulverizer 18 may be as disclosed in U.S. Pat. No. 5,944,268 to Andela, which is hereby incorporated by reference herein in its entirety. As discussed therein, pulverizers so designed efficiently reduce frangible materials such as glass to small fragments, typically ⅛″ in maximum dimension, while allowing much larger items of nonfrangible materials, such as paper, plastic, aluminum and steel, to pass through, enabling a simple size-based separation to be carried out.

More specifically, selective reduction of glass takes place inside the pulverizer due to the design of the preferred flexible impactors or flails as disclosed in Andela U.S. Pat. No. 5,944,268 mentioned above. As discussed therein, the pulverizer preferably comprises a pair of shafts each carrying a number of flexible flails rotating centrally within relatively closely-fitting cylindrical housings. A “tornado” type of air flow pattern created by the flails breaks the glass (or other breakable material) into fine granules, the edges of which are rounded as these particles collide with each other. However, items of materials that do not break well on impact, such as paper, plastics and metal, remain relatively whole in the tornado and exit the pulverizer as larger items, allowing a simple size based process to be used to separate the small glass granules from the larger fragments of undesired materials. The flexibility of the flails allows them to deflect, allowing plastic containers and cans to slide past the flails, so that such items are not shredded and the flails are not damaged. There are no internal screens or pinch points in the pulverizer that causes material to be reduced through any kind of “grinding” action; the glass particles are reduced by mutual contact. Paper such as bottle labels is effectively removed in the pulverizer as well; any remaining paper adhering to the glass particles is removed in the subsequent washing step.

A second conveyor 20 then carries the glass particles to the trommel 22. A suitable trommel is available from Andela Products, Ltd. of Richfield Springs, N.Y. under model number ATROM-104. As discussed, this equipment may be essentially as described in U.S. Pat. No. 5,620,101 to Andela et al, which is hereby incorporated by reference herein in its entirety. As shown in detail therein, the trommel comprises a cylinder comprising two coaxial screens of differing mesh sizes, which are rotated about an axis inclined at a slight angle to the horizontal. Accordingly, a size-based separation takes places as the mesh drum rotates and the particulate material moves therealong, with the smaller particles falling through the finer mesh at the upper end of the mesh drum, and so on. The effect is to sort the smallest glass particles into a first bin 54, labeled “sand” in FIG. 2; particles of up to a larger size fall into a second bin 56, labeled “gravel”; the remainder, typically larger particles or items of materials other than glass, is conveyed by a third conveyor 58 into a third bin 60 labeled “trash”. Preferably, the larger-size glass particles collected in the “gravel” bin 56 are returned to the pulverizer 18, to be further reduced, so that ultimately the highest possible fraction of the post-consumer waste glass stream is reduced to a small “sand” particle size, preferably ⅛″ or less.

Step B in the process of the invention is that of washing the particulate glass. As discussed above, this can be accomplished using screw or auger washing equipment. Equipment generally suitable for this step is sold under the trade name “Scrommel” by a company of that name, located in Salinas, Kans., for separating out the constituents of uncured concrete for reuse, and is illustrated schematically at step B in FIG. 1.

As discussed above, this equipment may comprise a first settling basin 26 into which the particulate material is dropped; a second surge hopper 24 may be provided to regulate the flow. Basin 26 is filled at least partially with water, as indicated at 62. If necessary, detergent or the like may be added to ensure the cleanliness of the glass. As mentioned above, any paper and plastic remaining in the stream of glass particulates tends to float to the surface of the water in the basin, and can be readily removed, while sugars and other organic materials adhering to the glass particles are dissolved in the water, and the glass particles sink.

A first helical screw conveyor 30, comprising an auger 64 driven for rotation by a motor 68, with its lower end extending into the settling basin 26, and fitting relatively tightly into a tubular enclosure 66, draws the particulate glass from the bottom of the basin 26 along enclosure 66. The glass then drops into a second settling basin 28 associated with a second similar helical screw conveyor 32, from which it is removed by a second similar auger 70. For further size separation, the first screw conveyor 30 can be fitted with a screen fitting around the auger screw, allowing smaller material to fall through the screen, and out an exit aperture in the enclosure; in this case the smaller material would be conveyed to the next stage in the process, and the larger material returned for further reduction or separation.

The washing stations thus provided can of course be multiplied if necessary, and detergents, solvents, or heated water can be employed. Dewatering takes place as the particulate glass travels upwardly along the screw conveyors; further dewatering can be performed, e.g., using centrifuge equipment, between this washing step and the subsequent drying step, as indicated at 71.

FIG. 1 also shows schematically at C the next step in the process of the invention, drying the washed glass. As illustrated, in the preferred embodiment the glass particles are dried using fluidized bed equipment, although other known drying equipment, such as rotary kiln equipment, is of course also within the scope of the invention. As mentioned above, the design of fluidized bed equipment, in particular for classification of particles by size, is discussed in detail by Adham, Classify Particles Using Fluidized Beds, CEP Magazine, 54-57 (2001).

The basic operation of such equipment is as follows, referring to FIG. 1. The particulate product to be classified and/or dried is introduced to the equipment 34 as at 72, e.g. by conveyor from the preceding step. A perforated or slotted plate or screen 40 may be provided to support the product as necessary, and is oscillated to move the product along, as indicated by arrows 76. A high-velocity stream of air, ordinarily heated, is introduced at 36. As indicated at 78, the air stream is ducted so as to blow upwardly through the “floor” provided by plate 40. The effect is to blow the incoming particulates into the air volume above plate 40, suspending them in the air stream, and thus forming the so-called fluidized bed. Clearly the particles in the bed will be buffeted by the heated air stream, and will be very effectively dried. The heavier particulates can be removed at 82, as they fall off the end of the oscillating plate 40. As the smaller particles or “fines” are lighter for their relative size, they will be lifted further upwardly by the air stream, and may be removed along with the exhausted air at 80. The heated air can be separated from the fines, filtered to remove the likely dust and particles of paper and the like, as well as some pulverized glass, and returned to the inlet of the apparatus used to heat the inlet air stream, saving some heating cost. A further vibratory screen might be added directly after the dryer, e.g., to perform a further size-based separation to further classify the glass granules for other markets.

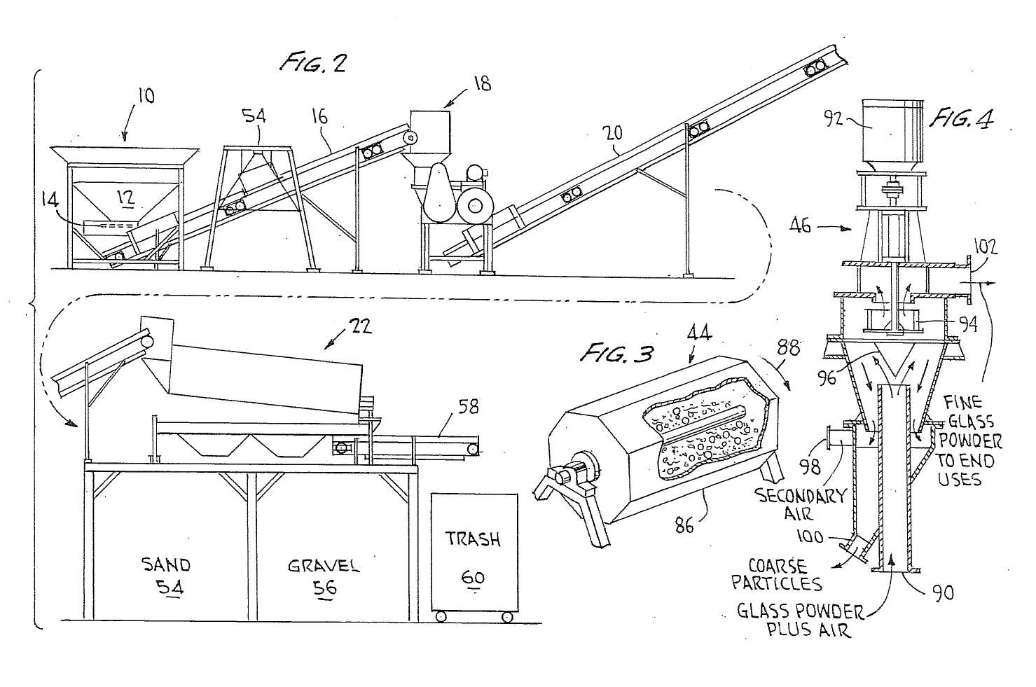

As indicated above, the final principal step in the process of making glass powder from a typical stream of post-consumer waste glass according to this aspect of the invention is grinding the particulate glass to a powder of generally uniform size of approximately 250 mesh minus, and preferably 325 mesh minus. As illustrated in FIG. 1, this can be accomplished using ball milling equipment 44 for the grinding step, with a classifier 46 provided to ensure that any larger material that may avoid reduction is returned to the ball mill for further grinding. FIG. 3 shows a perspective, partly cut away view of a ball mill 44 and FIG. 4 shows a cross-sectional view through a particular type of classifier 46. Other types of grinding and classification equipment are within the scope of the invention.

As discussed above, and as illustrated by FIG. 3, in one embodiment, the ball mill 44 comprises a steel drum 86, typically round or polygonal in cross-sectional configuration, supported for rotation about a central axis as indicated at 88. If the grinding is performed in a batch process, a quantity of glass particulates to be ground are charged into the drum 86 through an inlet port (not shown), along with a number of steel balls or similar heavy objects. As the drum is rotated, the balls gradually reduce the particulates to powder. After a suitable period of time, the powder is removed, again through a port (not shown). Alternatively, ball mills are known with constant inlet and outlet flow, and these are also within the scope of the invention. The ball milling process may thus be accomplished with a constant inlet and outlet flow, or, alternatively, in batches during which the glass particulates are reduced for a suitable amount of time.

In accord with another embodiment, the drum of the ball mill 44 is stone lined, and more preferably jasper lined. In addition, the balls of the ball mill have a non-metallic surface, and are preferably of a ceramic composition. This construction prevents the powder from acquiring metal microparticulates which can discolor the powder. The resulting glass powder is bright white in color.

After milling, the powder is then preferably conveyed, typically by an air stream, to the inlet of a classifier 46. Suitable equipment, as illustrated in FIG. 4, is available from Comex AS, Trondheim, Norway. Where the desired product is a bright white glass powder the relevant surfaces of the classifier are optionally coated in a ceramic material to prevent any discoloration to the powder. The stream of glass powder and remaining larger particles in air enters the classifier 46 through a vertical inlet 90 at the lower extremity of the unit. A motor 92 drives a rotor 94, pulling the inlet stream upwardly. The stream is dispersed around a static distribution cone 96, where coarse particles immediately settle in the lower velocity air stream, and are urged toward the conical outlet and fall toward the bottom of the classifier, to be withdrawn at 100. Secondary air is introduced at a further tangential inlet 98, to wash off finer particles that might otherwise adhere to the coarse particles. Fines introduced with the inlet stream are pulled through the rotor and exit at 102; these form the powdered glass produced according to the process of the invention, and accordingly are conveyed to an end use, bagged for storage or shipment, or simply accumulated in a bin. As mentioned above, and depending on the values of “coarse” and “fine” in the actual operation of the classifier 46, the coarse particles may be returned to the ball mill 44 for further reduction.

An advantage of a continuous process is that significantly increased consistency is provided to the powdered glass. The particles drawn out through the exit 102 of the classifier fall under a predictable and narrow distribution curve of quantity to size. At least 60% of the glass powder produced according to the process described herein should be 250 mesh size or finer, and should contain no more than 2% moisture. The increased consistency provides greater performance and reliability when using the powdered glass as a gelling agent and/or filler in polymerizable compositions as further discussed below.

The size, shape, and material characteristics of the powdered glass produced by this process provides numerous benefits to incorporating the powdered glass into cast solid surface materials used to form countertop surface applications.

As discussed above, cast solid surfaces contain a combination of various components, including a polymer, one or more fillers, and one or more gelling agents. In addition, a cast solid surface may include acid esters, an epoxy, and other components known in the art for varying the composition's mechanical properties, appearance, and/or the process by which the composition is formed. The present invention utilizes the powdered glass, which is produced from the process described in detail above, in various embodiments in which the powdered glass is used as a filler, gelling agent, or both in polymerizable compositions as further discussed below. The use of the powdered glass disclosed herein in the cast solid surfaces creates products that are cheaper to produce, stronger, safer, and more environmentally friendly.

A first embodiment of the invention comprises a cast solid surface material that includes a resin and a filler. The resin may include a monoethylenically unsaturated resin such as acrylonitrile, methacroylonitrile, and vinyl acetate, an acrylic resin or polymer, or a combination of monomers which can be polymerized, such as methyl methacrylate and other alkyl acrylates and methacrylates in which the alkyl groups can be from 1-18 carbon atoms, styrene, substituted styrenes, vinyl acetate, acrylonitrile, methacrylonitrile, acrylic and methacrylic acids, 2-vinyl- and 4-vinylpyridines, maleic acid, maleic anhydride and esters of maleic acid, acrylamide and methacrylamide, itaconic acid, itaconic anhydride and esters of itaconic acid and the like, and mixtures thereof. Multifunctional monomers for crosslinking purposes can also be included, such as unsaturated polyesters, alkylene diacrylates and dimethacrylates, allyl acrylate and methacrylate, N-hydroxymethylacrylamide and N-hydroxymethylmethacrylamide, N,N′-methylene diacrylamide and dimethacrylamide, glycidyl acrylate and methacrylate, diallyl phthalate, divinylbenzene, divinyltoluene, trimethylolpropane triacrylate and trimethacrylate, pentaerythritol tetraacrylate and tetramethacrylate, triallyl citrate and triallyl cyanurate, and the like, and mixtures thereof. Additional resins known in the art may be used, examples of which are further defined in U.S. Pat. Nos. 4,107,135 to Duggins, et. al.; U.S. Pat. No. 6,387,985 to Wilinson, et al.; U.S. Pat. No. 3,488,246 to Duggins, Re. 27,093 to Slocum, and Pub. No. 2006/0293449 to Weberg et al. (hereinafter, “DuPont Art”), all of which are herein incorporated by reference in their entireties.

The filler includes at least a portion of the powdered glass disclosed herein, and may also include calcium carbonate, calcium sulfate, clay, silica, calcium silicate, alumina trihydrate, crushed natural stone such as fragments of rock or mineral matter found in nature (e.g., quartz, quartzite, marble, granite, feldspar, and the like), decorative additives, titanium dioxide, titanates, barium sulfates, white leads, lithopone, china clays, magnesite, mica, iron oxides, pigments, and other fillers known in the art.

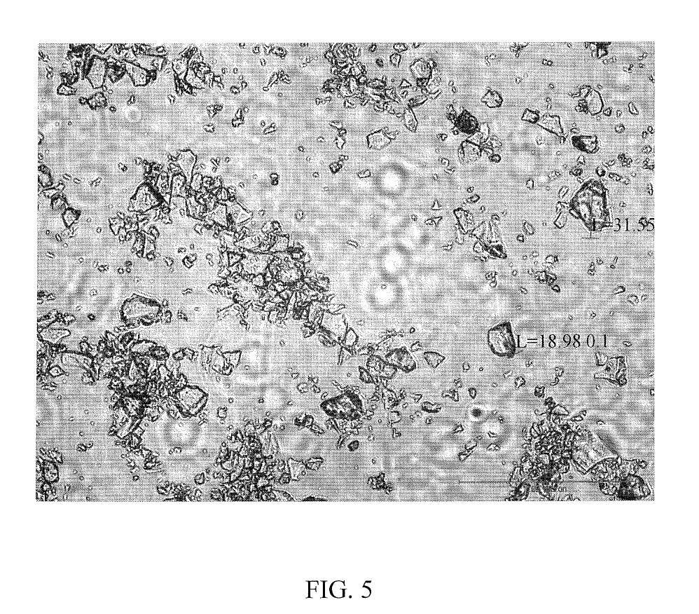

When used as a filler, the glass powder particles increase the tensile strength of the compositions. FIG. 5 shows an electron micrograph of particles of the glass powder produced by the above described process. The picture was taken without the powder being subjected to any kind of manipulation or compression other than the effects, if any, inherent in the standard transportation of the powder from its manufacturing location to the lab where it was examined. As shown, the tegular and angular glass particles are small and have a high aspect ratio and a natural tendency to pack tightly together, which allows for a high packing ratio per unit volume in compositions into which the glass powder is added. The glass powder thus fills much of the empty space or gaps in the composition which may otherwise be present if the standard fillers known in the art were used instead.

These characteristics of the glass powder give the compositions into which it is mixed greater deflection capability (by virtue of the high aspect ratio of the glass particles), and thus increased capacity to absorb stresses without the cracking that often occurs during solidification due to differences in the thermal expansion coefficients of the resin and the fillers being used. The high packing ratio of the glass powder makes it an excellent filler from a functional standpoint on account of the increased tensile strength that it gives to the composition, and from an aesthetic standpoint on account of its light transmissive properties, both of which can be varied and/or mitigated by modifications made to the drum of the ball mill 44 that grinds the glass powder as discussed above.

As the glass powder is inert, it may be incorporated into a wide variety of solid surface materials containing a resin and a filler. Preferably, such materials contain at least 5% by weight of the resin and at least 40% by weight of the filler. A first example of the first embodiment of the invention includes 10-35% by weight of methyl methacrylate as the resin and between 40-85% of inert additives (including the glass powder disclosed herein) as the filler. A second example of the first embodiment includes 5% to 15% of an acrylic as the resin and 85% to 95% of both crushed natural stone and the powdered glass described herein as the filler. Further information concerning the production and procurement of these and additional such compositions may be found in the DuPont Art, which has been incorporated by reference, and specifically with respect to U.S. Pat. No. Re 27,093 (Slocum) and U.S. Pat. No. 6,387,985 (Wilkinson). The glass powder may be used to replace at least a portion of the inert additives and/or natural crushed stone filler disclosed therein.

In producing cast solid surface materials made from resins and fillers, one of the problems encountered is that the compositions must have reasonable flow (to enable proper mixing and/or conveyance from one location to another) but not exhibit significant filler settling, which can lead to non-uniformity in the solidified product and possibly even warped products. Gelling or coupling agents have been used in the art, but attempts to thicken the polymerizable portion of the composition to prevent such settling have had the unintended consequence of preventing deaeration of the entrained air that is inevitable during the mixing of the components. The ability of the glass powder disclosed herein to reduce empty space in the compositions to which it is added coupled with the material properties of the glass itself, including its inherently low surface tension with air, renders the glass powder well suited for acting as a gelling or coupling agent that will also allow for greater de-aeration of entrained air during mixing.

Thus, a second embodiment of the invention comprises a solid surface material that includes a resin, a filler, and a gelling or coupling agent which includes the glass powder disclosed herein, and optionally includes other gelling or coupling agents known in the art to control the viscosity of polymerizable compositions.

Typical gelling and/or coupling agents include silanes, titanates, zirconates, bis urea crystals, cellulose acetate butyrates (CAB), high aspect fibers, polymer powders, filler bridging agents, fumed silica, and other agents known in the art. These gelling agents are generally expensive. A first example of the second embodiment of invention is a solid surface material containing a typical resin known in the art, a filler that preferably includes crushed natural stone such as granite or marble, and a gelling agent that at least partially includes the glass powder produced from the process described in detail herein. The gelling agent may additionally or alternatively include the other gelling agents discussed above.

Other embodiments of the invention include a solid surface material containing a resin, filler, a gelling agent that at least partially includes the glass powder produced from the process described in detail herein, as well as an epoxy, a phosphoric acid, and at least one free radical initiator. In these embodiments, the filler comprises at least 50% by weight of the material, and while the reaction of the phosphoric acid and the epoxy help to control the viscosity, the powdered glass is used as a gelling (sag) agent.

Additional embodiments of the invention include a solid surface material containing a resin, a filler, and a gelling agent where the resin contains methylmethacrylate polymer-in-monomer sirup, the filler contains 30-70% calcium carbonate, and the gelling agent contains a quantity of glass powder equal to 0.1%-1.0% of the weight of the calcium carbonate. In these embodiments, the glass powder acts as the dispersing (gelling) agent and is proportional to the amount of filler used in the material. Further information concerning the production and procurement of these and additional compositions may be found in the DuPont Art, which has been incorporated by reference, and specifically with respect to U.S. Pat. No. 3,488,246 (Duggins).

Cast solid surface materials which include glass powder manufactured from post-consumer waste glass and used as a partial substitute for gelling agents and/or fillers used in the various compositions that create the materials are substantially more environmentally beneficial. Post-consumer waste glass is generally the most difficult type of waste glass to recycle into a different product, as the waste stream is dirty, varies by quality and type, is unsorted, and is mixed with trash from which it must be separated. Moreover, these aspects of post-consumer waste glass present hurdles for achieving a method of continuous processing of a post-consumer waste glass stream that must be overcome in order to provide an economy of scale necessary for commercial production of a glass powder from such a source and to provide a consistency of product necessary for proper use in polymerizable compositions. However, once properly achieved, the resulting products have a tremendous environmentally beneficial impact.

In fact, recycling the post-consumer waste glass stream into a glass powder is not only beneficial to the environment, but also carries direct financial benefits to the end user. For example, cast solid surface materials manufactured with such products can be marketed as ‘green,’ an aspect that will appeal to many consumers, as well as to potential manufacturers, distributors, and contractors who would be given greater NSF ratings for creating and selling such products, and provide contractors with higher LEED (Leadership in Energy and Environmental Design) points which can translate into tax credits and other benefits. For example, the LEED green building rating system developed by the U.S. Green Building Council provides LEED certification for new construction and renovation projects. LEED is a point based system in which projects earn points for satisfying specific green building criteria, including the use of post-consumer recyclable materials. A higher total number of points has been shown to translate into increased occupancy rates, higher chargeable rents, and additional tax credits for the builder. Therefore, it is appreciated that the use of post-consumer waste glass as a constituent of solid surface materials used in various building applications, such as, for example, countertop surfaces, has an advantage not provided by the fillers and/or gelling agents formed from un-recyclable materials or recyclable materials which incorporate pre-consumer post-industrial waste materials.

Accordingly, those of skill in the art will appreciate that according to the invention, readily available post-consumer waste glass is removed from the waste stream and processed to create glass powder in industrial quantities that can be used in cast solid surface materials. More specifically, according to the invention, part of the post-consumer waste glass stream that is normally directed into landfills is diverted and processed into a powder that is clean and dry enough for applications that are usually reserved for non-recycled materials. Although the invention is described herein as implemented using particular machinery, this in no way should limit the scope of the invention but as merely providing illustrations of some of the presently preferred embodiments of this invention.

There have been described and illustrated herein several embodiments of cast solid surface materials manufactured from polymers and post-consumer waste glass. While particular embodiments of the invention have been described, it is not intended that the invention be limited thereto, as it is intended that the invention be as broad in scope as the art will allow and that the specification be read likewise. Thus, while embodiments of solid surface materials with specifically defined component weights, ratios/concentrations, and sizes have been defined, it will be appreciated that other component weights, ratios/concentrations, and sizes may be used as well, and that the examples given with respect to the disclosed embodiments are meant to be examples only, and not limitations on the respective embodiments to which they refer. In addition, while specific cure times, temperatures, and methods for preparation have been disclosed and/or incorporated by reference, it will be appreciated that simple modifications to such cure times, temperatures, and methods for preparation may be made to accommodate the glass powder disclosed herein as a gelling agent, filler, or both. It will also be understood that while a continuous process is disclosed for producing powdered glass from post consumer waste glass, individual steps of the continuous process, such as, for example, the ball milling process, may be batch processes that are periodically stopped while maintaining the continuity of the process in its entirety. It will therefore be appreciated by those skilled in the art that yet other modifications could be made to the provided invention without deviating from its spirit and scope as claimed.

What is claimed is:

1. A solid surface material suitable for use as a countertop, comprising:
a) a resin; and
b) a filler including glass powder produced from a process comprising,
i) supplying a stream of post-consumer waste glass containing items of non-frangible materials,
ii) pulverizing the stream in a manner such that consumer waste glass in the stream is reduced to fragments of average maximum size ⅛ inch or less, while non-frangible items are not reduced to said maximum size,
iii) performing a size-based separation of the reduced glass fragments from the non-frangible items,
iv) washing the reduced glass fragments to separate plastic and paper fragments and organic contaminants therefrom,
v) drying the washed glass fragments to a moisture content of no more than about 2% by weight,
vi) grinding the dried glass fragments into a glass powder in a mill,
vii) removing the glass powder,
viii) returning the remaining particles to said grinding at step vi) for grinding with additional dried glass fragments received for grinding after said drying at step v), and
ix) repeating said removing and said returning at steps vii) and viii), respectively, for continuous manufacturer of the glass powder.

2. A solid surface material according to claim 1, wherein:
at least about 60% of particles of said glass powder are of no more than 250 mesh particle size.

3. A solid surface material according to claim 2, wherein:
said grinding of step vi) is performed in a ball mill.

4. A solid surface material according to claim 3, wherein:
said ball mill includes a drum lined with stone and used ceramic grinding media.

5. A solid surface material according to claim 1, wherein:
said resin is 5 to 35 percent by weight of said material.

6. A solid surface material according to claim 1, wherein:
said filler is at least 40 percent by weight of said material.

7. A solid surface material according to claim 1, wherein:
said filler includes crushed natural stone.

8. A solid surface material according to claim 7, wherein:
said crushed natural stone and said powdered glass of said filler are 85 to 95 percent of said material by weight.

9. A solid surface material suitable for use as a countertop, comprising:
a) a resin;
b) a filler; and
c) a gelling agent including glass powder produced from a process comprising,
i) supplying a stream of post-consumer waste glass containing items of non-frangible materials,
ii) pulverizing the stream in a manner such that consumer waste glass in the stream is reduced to fragments of average maximum size less than ⅛ inch, while non-frangible items are not reduced to said maximum size,
iii) performing a size-based separation of the reduced glass fragments from the non-frangible items,
iv) washing the reduced glass fragments to separate plastic and paper fragments and organic contaminants therefrom,
v) drying the washed glass fragments to a moisture content of no more than about 2% by weight,
vi) grinding the dried glass fragments into a glass powder, at least about 60% of particles of said glass powder being no more than 250 mesh particle size, wherein the grinding is performed in a mill that grinds the dried glass fragments,
vii) removing the glass powder, and
viii) returning the remaining particles to said grinding step for grinding with additional dried glass fragments received for grinding after said drying step in a continuous glass powder manufacturing process from a supply of a post-consumer waste glass stream.

10. A solid surface material according to claim 9, wherein:
at least about 60% of particles of said glass powder are of no more than 325 mesh particle size.

11. A solid surface material according to claim 9, wherein:
said filler includes crushed natural stone.

12. A solid surface material according to claim 11, wherein:
said natural stone includes granite.

13. A solid surface material according to claim 11, wherein:
said natural stone includes marble.

14. A solid surface material according to claim 9, wherein:
said resin includes a methylmethacrylate polymer.

15. A solid surface material according to claim 9, wherein:
said filler includes calcium carbonate.

16. A solid surface material according to claim 15, wherein:
said calcium carbonate is 30 to 70 percent by weight of said material.

17. A solid surface material according to claim 16, wherein:
said gelling agent is 0.1 to 1.0 percent by weight of a weight of said calcium carbonate.

18. A solid surface material according to claim 9, further comprising:
an epoxy;
a phosphoric acid; and
at least one free radical initiator.

19. A solid surface material according to claim 18, wherein:
said filler is at least 50 percent by weight of said material.

20. A solid surface material according to claim 19, wherein:
said gelling agent includes at least one of silanes, titanates, and zirconates.
